(19) United States
(12) Patent Application Publication
(10) Pub. No.: US 2007/0045277 A1
(43) Pub. Date: Mar. 1, 2007

(54) Active control of heating systems for food service applications

(76) Inventors: Valdislav K. Smarda, Fairfield, OH (US); William A. Pollack, South Lebanon, OH (US)

Correspondence Address: William A. Pollack, 200 East Pike Street, South Lebanon, OH, 45065, US

(21) Appl. No.: 11/450,988

(22) Filed: Jun. 12, 2006

Related U.S. Application Data
(60) Provisional application No. 60/711,460, filed on Aug. 25, 2005.

(51) Int. Cl. F24C 7/10; F27D 11/00

(52) U.S. Cl. 219/386

(57) ABSTRACT

Food service heating systems and methods that include a heating element configured to heat a food service product in a heating area. A controller is coupled to the heating element and configured to control an aspect of the heating element. A sensor arrangement is configured to sense motion of the food service product within the heating area. The controller detects motion of the food service product within the heating area using the sensor, and controls the aspect of the heating element in response to the motion. Methods for controlling a food service product heating system involve providing a heating element configured to heat a food service product in a heating area. Motion of the food service product is detected within the heating area. An aspect of the heating element, such as power level, ON/OFF condition, number of active elements, or other aspect, is controlled in response to the detected motion.

### RELATED PATENT DOCUMENTS

This application claims the benefit of Provisional Patent Application Ser. No. 60/711,460, filed on Aug. 25, 2005, and Provisional Patent Application Ser. No. 60/______, filed on Sep. 22, 2005 entitled “Active Control Of Heating Systems For Food Service Applications” [first inventor Smarda, Lada K], both to which priority is claimed pursuant to 35 U.S.C. §119(e) and which are both hereby incorporated herein by reference.

### FIELD OF THE INVENTION

The present invention relates, in general, to controllers for heating systems and, more particularly, to active control of heating systems for food service applications.

### BACKGROUND OF THE INVENTION

Customers of food service organizations, such as restaurants, prefer hot food products served at appetizing temperatures. For example, if a customer of a restaurant orders a hot baked potato, and it is served at a cool temperature, the customer may become dissatisfied. The restaurant may lose the customer to a competitor.

In order to provide hot food products to customers, food service organizations may employ heating systems to maintain prepared food at an elevated temperature before service and/or during staging of food during production. If large numbers of customers are being served, food may need to be staged and heated in order to provide a group with their orders concurrently. These heating systems consume significant amounts of energy, and may create uncomfortable environments for the food service workers.

However, heated food products often need to be maintained at an elevated temperature in order to reduce food borne illnesses. The Council for Agricultural Science and Technology estimates 6.5 to 33 million people become ill from microorganisms in food resulting in as many as 9000 needless deaths every year. Problems with food borne contamination have prompted the actions of government agencies to prepare guidelines and/or rules for sanitation requirements such as, for example, the Indiana State Department of Health Title 410 IAC-7-22 Certification of Food Handler Requirements. Requirements such as these often include the use of heating for food as it is awaiting service to the customer, while preparing for presentation, during service, and when re-heating food product. Many other states are in the process of adopting, or have already adopted, similar requirements. Using fast food restaurants as an example, all states have health codes requiring that food products, such as hamburgers, be maintained at a certain temperature, typically in the range of 140 degrees to 150 degrees F.

Whether because of the desire to serve food at appetizing temperatures, or for health requirement compliance, heating systems may be used within the food service organization. Numerous devices have been introduced to the marketplace to accomplish the desired heating. One known system includes a planar sheet onto which the wrapped or unwrapped food products are placed, and an infra-red heating system is placed above the sheet with rays from its heating bulbs directed downwardly toward the food. In other systems, plates may be pre-heated before placing hot food products. Plates of hot food may be placed under heat lamps, or other heat systems may be utilized to pre-heat the plates.

Heating systems are often used within organizations that are simultaneously using air-conditioning to cool the ambient air. Energy is wasted, and food service personnel are often uncomfortable due to these heating systems.

For reasons stated above, and for other reasons which will become apparent to those skilled in the art upon reading the present specification, there is a need for systems and methods that provide for controllers for heating systems. There is a particular need for active control of heating systems for food service applications. The present invention fulfills these and other needs, and addresses deficiencies in known systems and techniques.

### SUMMARY OF THE INVENTION

The present invention relates, in general, to controllers for heating systems and, more particularly, to active control of heating systems for food service applications. In particular embodiments, a food service heating system includes a heating element configured to heat a food service product in a heating area. A controller is coupled to the heating element and configured to control an aspect of the heating element. A sensor arrangement is coupled to the controller and configured to sense motion of the food service product within the heating area. The controller is configured to detect motion of the food service product within the heating area using the sensor, and to control the aspect of the heating element in response to the detected motion.

Other embodiments are directed to methods for controlling a food service product heating system involving providing a heating element configured to heat a food service product in a heating area. Motion of the food service product is detected within the heating area. An aspect of the heating element, such as power level, ON/OFF condition, number of active elements, or other aspect, is controlled in response to the detected motion.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is a flow chart of a method for controlling a heating system in accordance with the present invention;

FIG. 2 is a schematic for a circuit useful for controlling a heating element for food services in accordance with the present invention; and

FIG. 3 is a schematic for a controller useful for controlling a heating element for food services in accordance with embodiments of the present invention.

In the following description of the illustrated embodiments, references are made to the accompanying drawings, which form a part hereof, and in which is shown by way of illustration various embodiments in which the invention may be practiced. It is to be understood that other embodiments may be utilized, and structural and functional changes may be made without departing from the scope of the present invention.

### DETAILED DESCRIPTION OF THE INVENTION

The present invention relates, in general, to controllers for heating systems and, more particularly, to active control of heating systems for food service applications. Many restaurants consume large quantities of electricity tom run heat lamps for heating food. Often these lamps are left on continuously, even when not being actively used. Embodiments of the present invention are useful for reducing energy consumption and improving kitchen working-conditions by regulating these heat lamps.

Methods and devices employing active control of heating systems for food service applications in accordance with the present invention may incorporate one or more of the features, structures, methods, or combinations thereof described herein below. For example, active control of heating systems for food service applications may be implemented to include one or more of the features and/or processes described below. It is intended that such a device or method need not include all of the features and functions described herein, but may be implemented to include one or more features and functions that, alone or in combination, provide for unique structures and/or functionality.

Embodiments of the present invention are directed to a device that detects the usage of a heating system, such as a heat lamp, heating station, or the like, used to heat food in a food service environment such as a kitchen, restaurant, or other food service environment. If the kitchen server does not add or remove food within a predetermined time, the heating device is shut off until additional food is inserted. The detection of food insertion or removal may be performed automatically, such as by using an active or passive optical arrangement, for example.

Turning off a heating system automatically in accordance with embodiments of the present invention provides the food service organization with lowered energy use for electricity used to power the heating system, and lower energy use for HVAC used to process kitchen environment, as well as improved operating conditions for kitchen workers. This may further lead to increased kitchen productivity and/or employee satisfaction with the work environment.

Systems in accordance with embodiments of the present invention may be less likely to grossly overheat a food item, since the heating system turns off after a certain time. This may reduce the chance of accidental fires should an item be left underneath the heating system.

Other embodiments of devices in accordance with the present invention are directed to a device for regulating the temperature of a food item in a food service organization. Presence or absence of food may be determined, such as by using a passive optical detection system. A server may load and unload food under the heating device. Upon insertion of new food, the food's present temperature may be detected and recorded. A is control strategy may be applied to the heating element in order to regulate the food temperature. The control strategy may involve temperature sensing, a computational algorithm, and power control of the heating system. Removal and insertion of the food may be detected by passive optical arrangement.

Various control methodologies may be used, such as, for example: sample and hold mode, where the food temperature may be caused to equal the food's initial temperature, until the food item is removed; and enforce mode, where the food temperature may be held at a certain set point until removed. The specific set point may be programmed or configured into the controller via an input arrangement, such as a key pad, may be selected using DIP switches, jumpers, or the like, or may be selected using a switching arrangement. The set point may or may not be customer adjustable.

These methodologies may each, or in combination, be used with automatic shut-off of the heating system when not used, as described above. Using a heating system control methodology in accordance with embodiments of the present invention provides lower energy use for electricity used to power the heating system, lower energy use for HVAC used to process the kitchen environment, and may improved operating conditions for kitchen workers. This may lead to increased kitchen productivity and/or improved product quality.

Heating system control devices in accordance with embodiments of the present invention may reduce food overheating and/or excessive cooking if food products are left under the heating system for long periods of time. The customer will receive the food product at a temperature closer to the ideal temperature, even after being under the heating systems for extended time periods. Embodiments of the invention may be used to maintain a food or food service container above a minimum temperature, below a maximum temperature, and/or within an acceptable range of temperatures.

Further embodiments of heating system control devices in accordance with the present invention may include a display for displaying the actual and desired temperatures of the food. Other embodiments may further be configured to transmit food temperature data to a management system for quality control purposes or statistics. For example, wireless transmission of sensed temperatures from a non-contact optical temperature measurement system used in the temperature controller feedback on a device in accordance with the present invention may be received by a central computer in the food service organization. In one configuration, the heating system controller may be equipped with a short-range wireless communication interface, such as an interface conforming to a known communications standard, such as Bluetooth or IEEE 802 standards.

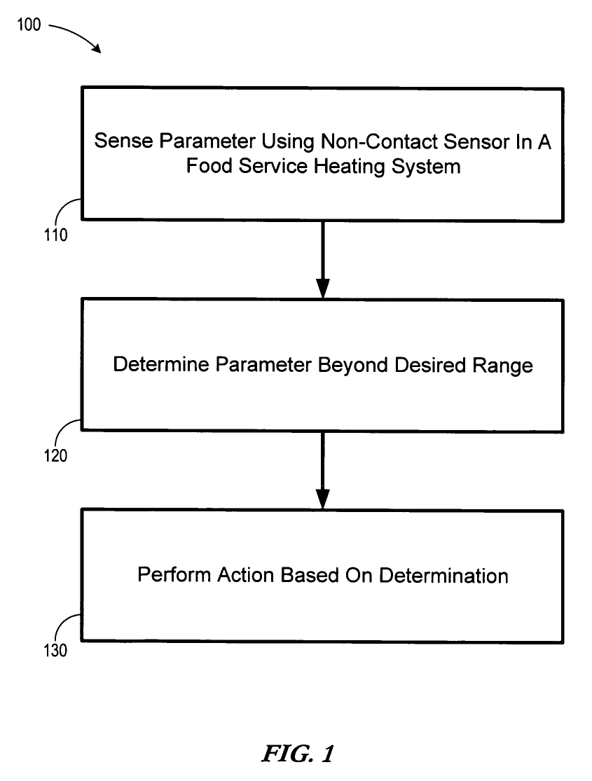

FIG. 1 is a flow chart of a method 100 for controlling a heating system in accordance with the present invention. A non-contact sensor is used to sense 110 a parameter corresponding to motion, the presence of a plate and/or food, and/or temperature, in accordance with embodiments of the present invention. If the sensed parameter is determined 120 to be beyond a desired range, then a corrective action is performed 130.

For example, a motion sensor may be used to monitor the motion in view of a sensor corresponding to a heating system location. If no motion is detected over a predetermined time period, then the heating system is turned off. Incorporating motion sensing in the active are of a heating system for food products provides reduced on-time for the heating system. For example, sensing motion of the food being slid under a heat lamp may be used to begin a countdown timer, and cause the heat lamp to turn on. After the countdown timer completes its countdown, the heat lamp may be turned off. As a specific example, the count down timer may be reset to 15 minutes every time motion is sensed in the heating are of a heat lamp. This would ensure that the heat lamp would turn off after 15 minutes of no sensed usage.

One embodiment of sensing motion may incorporate a beam blocking system, similar to systems currently used in garage door openers to detect objects in the path of the door. Another embodiment of a motion sensor may incorporate a scale that senses the weight of a food product on a surface under the heat lamp. A further embodiment of a system useful for detecting motion may incorporate a capacitance sensor that senses a change in capacitance in the area in which the food product is placed. In yet a further embodiment, a passive infra-red sensor may be used to sense the warmth of the food in the heating area.

Motion sensors suitable for use in systems in accordance with embodiments of the present invention may be purchased from The Electronic Goldmine, such as, for example, part numbers G4567, G12959, G9270. The manufacturer of the G4567 device, as an example, is Quorum, model AS-101 and/or RR-150. Other uses of this device include room security, intrusion detection, and other applications. Other sensors useful for systems in accordance with embodiments of the present invention may be acquired from MuRata, USA. These include sensors manufactured by MuRata, such as the MuRata passive infra-red (PIR) sensor, part number IRA-E700ST0, which may be referred to as a pyroelectric sensor.

In a particular embodiment using a PIR sensor, the average signal from the PIR sensor may be tracked. The instantaneous signal from the PIR sensor may be compared to the average signal level, and if the absolute difference of the instantaneous signal level minus the signal's average value over a predetermined time period is beyond a threshold level, then a motion event is detected. Alternate embodiments may include a blanking period to eliminate spurious events. Detection of a motion event may be used to reset a countdown timer to a predetermined count. The countdown timer then counts down, and if no resets occur, the heating system is turned off when the countdown timer gets to zero, or other defined point, for example.

In accordance with another embodiment of the present invention, the temperature and/or a change in the temperature of a food product may be sensed in the active region of a heating system. For example, a passive non-contact sensor may be used to sense the temperature under the sensor in a region that is heated by a heating system, such as a heat lamp. A processor, such as a computer or controller, may be used to control activation of the heating system, such as by turning on and off a heat lamp. The placing of food under a passive non-contact sensor may be determined by sensing the difference in temperature between the food and the shelf the food is being placed on. Detecting a change in the temperature may be used to start a timer and/or to initiate an algorithm in the processor to perform control strategies such as sample and hold mode, enforce mode, or other strategy and/or algorithm.

One control strategy useful with heating systems in accordance with the present invention involves the use of proportional automatic control of the heating elements. A processor may use measured values from a sensor, historical recollection, and desired temperature in a control loop such as a proportional-integral-differential (PID) loop, to control the energy delivered to heating elements. In this manner, rates of heating may be controlled. Heating systems incorporating PID loops may be more efficient and effective than merely controlling the on/off functions of a heating system. Other methodologies may also be used for controlling heating systems in accordance with embodiments of the present invention, such as neural networks, fuzzy logic systems, bang-bang methodologies, or other known control methodologies. As stated previously, these systems may be used to control the heating of plates or other food service containers as well as the food itself.

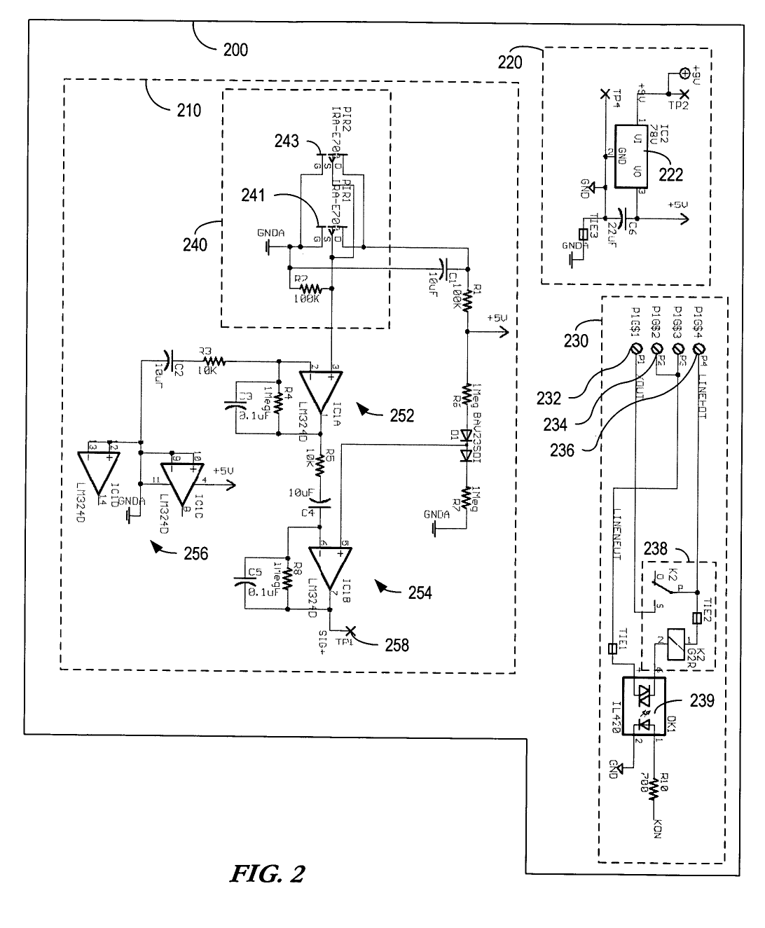

FIG. 2 is a schematic for a circuit 200 useful for controlling a heating element for food services in accordance with the present invention. The circuit 200 includes a sensor/signal module 210, a power module 220, and a relay module 230. The sensor/signal module 210 includes a sensor port 240 configured to couple to a first PIR sensor 241 and optionally a second PIR sensor 243, such as the PIR sensors described above, for example.

Embodiments of the present invention using two sensors, such as the two sensors 241, 243, may sense at two different wavelengths, which may reduce the sensitivity of temperature measurements on the emissivity of objects in the sensed region. The sensor port 240 provides a signal from the sensor to a filter/amplifier circuit 252 and a second stage filter/amplifier 254, which conditions and amplifies the signal from the sensor, and provides an output signal to a line 258 (designated as SIG+ in the circuit diagrams). Amplifiers/filters 256 are reserved for future use. In addition to filtering and/or amplification, signals may originate and/or be converted to digital form such as by using analog to digital converters. Digital signal analysis, such as statistical analysis, may be used to improve systems in accordance with the present invention. For example, a processor may determine that sequential measurements have a variance larger than expected from a food item. The variance may be used to determine that food is not present, and subsequently the control system may turn off the heat lamp until food is placed in the sensing region.

The power module 220 provides power to the circuit 200, such as by using a 9 volt battery through a regulator 222 to provide a 5 volt regulated output. As is known in the art, a heat lamp power source such as a 110 volt or a 220 volt alternating current source may be used with known power conditioning/converting systems to power the circuit 200 without the need for a battery.

The relay module 230 includes pins 232, 234 that connect to the heat source, such as the heat lamp, and a pin 236 that is coupled to the power line for the heat source. An opto-coupler/relay driver 238 is used to control a relay 239 in accordance with the present invention to turn ON/OFF the heat lamp in the embodiment illustrated in FIG. 2.

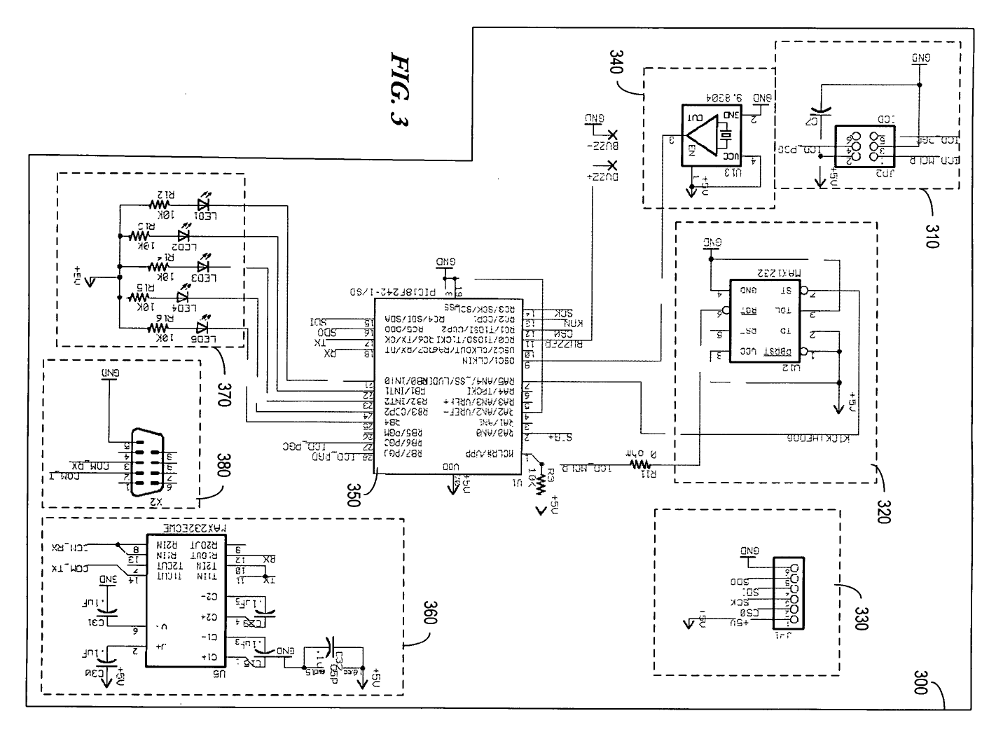

FIG. 3 is a schematic for a controller 300 useful for controlling a heating element for food services in accordance with embodiments of the present invention. The controller 300 illustrated in FIG. 3 includes a processor 350, a programming port 310, an oscillator 340, a power supply watchdog monitor 320, an input/output (I/O) port 330, a level shifter 360, a diagnostic I/O port 380, and a status display 370.

The processor 350 may be used to implement methodologies for controlling heating systems in accordance with the present invention, using, for example, algorithms, logic, and programming to perform strategies such as those described above. The processor 350 may be, for example, a PIC18F242-I/SO clocked by the oscillator 340, for example a 9.8 megahertz clock, as is illustrated in FIG. 3.

The processor 350 may be programmed using the programming port 310, and debugged using the diagnostic I/O port 380 as is known in the art. The power supply watchdog monitor 320 may be used to reset the processor 350 if errors occur, such as software lockup, loss of power supply, or other errors. The status display 370 may include LEDs to determine system status during operation. The level shifter 360 may be used to shift signal levels from, for example, 12 volt signals to TTL compatible levels. The port 330 may be used to couple, for example, an optical non-contact thermal sensor to the controller 300 for use with embodiments described above.

Systems in accordance with embodiments of the present invention may be implemented by, for example, using an add-on module wired into a customer's present heating station by a qualified electrician. It would thus be available as an aftermarket device that may be retro-fitted to existing infra-red heat lamp systems, for example. In other embodiments, a controlling system in accordance with the present invention may be included as an original equipment manufacturer (OEM) module available for purchase and integration into a restaurant OEM's product line.

Long-wave optical thermocouple units for systems in accordance with embodiments of the present invention are available from Exergen, such as, for example, models IRT/C.03K-140F and uIRT/C-K-140F. These units provide a low level analog output similar to a traditional contact thermocouple.

Noncontact infra-red (IR) sensors with digital output are available through Metris Instruments, Los Gatos, Calif. Sensors useful for systems in accordance with embodiments of the present invention include the TN901 and TN903 sensors.

It is understood that the components and functionality depicted in the figures and described herein may be implemented in hardware, software, or a combination of hardware and software. It is further understood that the components and functionality depicted as separate or discrete blocks/elements in the figures may be implemented in combination with other components and functionality, and that the depiction of such components and functionality in individual or integral form is for purposes of clarity of explanation, and not of limitation.

Illustrations of method steps, such as, for example, the steps illustrated in FIG. 1 show steps sequentially and in a particular order. There is no need to perform the steps in the order illustrated. Deviating from the illustrated order for some or all of the steps is contemplated by the inventor, and does not depart from the scope of the present invention.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

While preferred embodiments of the present invention have been shown and described herein, it will be obvious to those skilled in the art that such embodiments are provided by way of example only. Numerous variations, changes, and substitutions will be apparent to those skilled in the art without departing from the invention. Accordingly, it is intended that the invention be limited only by the scope of the appended claims.

What is claimed is:

1. A food service heating system, comprising:
a heating element configured to heat a food service product in a heating area;
a controller coupled to the heating element and configured to control an aspect of the heating element; and
a sensor arrangement coupled to the controller and configured to sense motion of the food service product within the heating area;
wherein the controller is configured to detect motion of the food service product within the heating area using the sensor, and to control the aspect of the heating element in response to the detected motion.

2. The system of claim 1, wherein the sensor arrangement comprises a non-contact sensor configured to sense a parameter corresponding to motion.

3. The system of claim 1, wherein the controller is further configured to transmit food temperature data to a management system.

4. The system of claim 1, wherein the controller is further configured to maintain the food service product above a minimum temperature or below a maximum temperature or within a predetermined range of temperatures.

5. The system of claim 1, wherein the heating element comprises a heat lamp.

6. The system of claim 1, wherein the controller comprises a proportional-integral-differential control algorithm.

7. The system of claim 1, wherein the sensor arrangement comprises a passive infra-red sensor.

8. The system of claim 1, wherein the sensor arrangement comprises a capacitance sensor configured to sense a change in capacitance in the area in which the food service product is placed.

9. The system of claim 1, wherein the sensor arrangement comprises a scale.

10. The system of claim 1, wherein the sensor arrangement comprises a beam blocking system.

11. The system of claim 1, wherein the sensor arrangement comprises a motion sensor.

12. The system of claim 1, wherein the sensor arrangement comprises two sensors configured to reduce the sensitivity of temperature measurements of objects in the heating area.

13. The system of claim 1, wherein the controller is further configured to provide a blanking period.

14. The system of claim 1, comprising a display for displaying one or both of the actual or desired temperatures of the food.

15. A method for controlling a food service product heating system, comprising:
providing a heating element configured to heat a food service product in a heating area;
detecting motion of the food service product within the heating area; and
controlling an aspect of the heating element in response to the detected motion.

16. The method of claim 15, wherein the aspect of the heating element is an on/off condition.

17. The method of claim 15, wherein the aspect of the heating element is an on/off condition, and wherein the heating element is turned off after determining an absence of motion in the heating area for a predetermined time period.

18. The method of claim 15, comprising programming a specific set point for the aspect into the controller using an input arrangement.

19. The method of claim 15, comprising sensing one or both of the temperature or a change in the temperature of the food product in the heating area.

20. The method of claim 15, comprising delaying a predetermined time period after detecting motion of the food service product within the heating area before controlling the aspect of the heating element in response to the detected motion.

21. The method of claim 20, comprising automatically shutting-off of the heating system after delaying the predetermined time period.

22. A device for controlling a food service product heating system, comprising:
means for heating a food service product in a heating area;
means for detecting motion of the food service product within the heating area; and
means for controlling an aspect of the heating element in response to the detected motion.
